(19) United States
(12) Patent Application Publication
(10) Pub. No.: US 2019/0253970 A1
(43) Pub. Date: Aug. 15, 2019

(54) ANTI-INTERFERENCE WIRELESS TRANSCEIVING SYSTEM

(71) Applicants: LUCIS TECHNOLOGIES (SHANGHAI) CO., LTD., Shanghai (CN); LUCIS TECHNOLOGIES HOLDINGS LIMITED, Grand Cayman (KY)

(72) Inventors: Lin ZHOU, Shanghai (CN); Defeng SHI, Shanghai (CN); Shan GUAN, FREMONT, CA (US)

(73) Assignees: LUCIS TECHNOLOGIES (SHANGHAI) CO., LTD., Shanghai (CN); LUCIS TECHNOLOGIES HOLDINGS LIMITED, Grand Cayman (KY)

(21) Appl. No.: 16/326,702

(22) PCT Filed: Aug. 19, 2016
(86) PCT No.: PCT/CN2016/096098

§ 371 Date: Apr. 16, 2019

(51) Int. Cl. H04W 52/02; H04W 72/04; H04W 16/14

(52) U.S. Cl. CPC H04W 52/0229; H04W 16/14; H04W 72/0446

(57) ABSTRACT

The present disclosure provides systems and methods for wireless anti-interference transceiving. The method may include one or more of following operations. A first signal may be received from a signal source. A second signal may be generated according to the first signal. A voltage of the second signal may be based on a power of the first signal. A third signal may be generated according to the second signal. One or more time slots in the third signal may be determined. Wireless signal transceiving may be performed in at least one of the one or more time slots.

### TECHNICAL FIELD

The present disclosure relates to systems and methods for wireless transceiving, and in particular, relates to systems and methods for wireless anti-interference transceiving.

### BACKGROUND

A wireless transceiver refers to a device that can receive and transmit wireless signals. Common wireless signals may include a radio wave, a microwave, an infrared ray, etc. The wireless transceiver may include a radio, a remote control, a radio detection and ranging (Radar), a mobile phone, or any other device that has a wireless transceiving function. On one hand, with the development of the wireless transceivers, more and more wireless signals are transmitted and/or received by the wireless transceivers. Therefore, it is necessary to avoid mutual interference between the wireless signals. On the other hand, as the function of the wireless transceivers becomes more and more abundant and the volume of the wireless transceivers becomes smaller and smaller, a plurality of different wireless transceiving modules are generally disposed on a same device. In this case, transmission signals of a wireless transceiving module can easily interfere with receiving signals of other wireless transceiving modules. Therefore, it is also necessary to avoid mutual interference between different wireless transceiving modules in the same device.

### SUMMARY

Some embodiments of the present disclosure provide a system. The system may include a receiving module, a power detection unit, a signal conditioning unit, a time slot selection unit, and a wireless transceiving module. The receiving module may receive a first signal from a signal source. The power detection unit may generate a second signal according to a power of the first signal. For example, a voltage of the second signal may be based on the power of the first signal. The signal conditioning unit may generate a third signal according to the second signal. The time slot selection unit may determine one or more time slots in the third signal. The wireless transceiving module may perform wireless signal transceiving in at least one of the one or more time slots.

In some embodiments, one or more time slots in the third signal may include a transmission time slot and a stop time slot.

In some embodiments, the wireless transceiving module may perform the wireless signal transceiving in the stop time slot of the third signal.

In some embodiments, the wireless transceiving module may delete a portion of the received first signal that is in the transmission time slot.

In some embodiments, the system may further include a coupler configured to adjust a size of the first signal.

In some embodiments, the signal conditioning unit may include a signal amplifier. The signal amplifier may amplify the second signal.

In some embodiments, the signal conditioning unit may include an analog to digital (AD) converter. The AD converter may acquire the second signal.

In some embodiments, the AD converter may include a judgment circuit. The judgment circuit may control the acquisition of the second signal.

In some embodiments, the system may further include a correction circuit. The correction circuit may correct the third signal according to a synchronization of the transmission time slot and the stop time slot of the third signal with the first signal.

Some embodiments of the present disclosure provide a method. The method may include one or more of the following operations. A first signal may be received from a signal source. A second signal may be generated according to a power of the first signal. For example, a voltage of the second signal may be based on the power of the first signal. A third signal may be generated according to the second signal. One or more time slots in the third signal may be determined. Wireless signal transceiving may be performed in at least one of the one or more time slots.

In some embodiments, the one or more slots in the third signal may include a transmission time slot and a stop time slot.

In some embodiments, performing wireless signal transceiving in at least one of the one or more time slots may include performing wireless signal transceiving in the stop time slot of the third signal.

In some embodiments, the method may further include deleting a portion of the received first signal in the transmission time slot.

In some embodiments, the method may further include adjusting a size of the first signal by a coupler.

In some embodiments, the method may further include acquiring the second signal by an AD converter.

In some embodiments, the method may further include controlling the acquisition of the second signal by a judgment circuit.

In some embodiments, the method may further include correcting the third signal according to a synchronization of the transmission time slot and the stop time slot of the third signal with the first signal.

Some embodiments of the present disclosure provide a computer-readable storage medium. The computer-readable storage medium may store executable instructions. The executable instructions may cause a computer device to perform one or more of the following operations. A first signal may be received from a signal source. A second signal may be generated according to a power of the first signal. For example, a voltage of the second signal may be based on the power of the first signal. According to the second signal, a third signal may be generated. One or more time slots in the third signal may be determined. Wireless signal transceiving may be performed in at least one of the one or more time slots.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

In order to illustrate the technical solutions related to the embodiments of the present disclosure, brief introduction of the drawings referred to the description of the embodiments is provided below. Obviously, the drawings in the following description are only some examples of the present disclosure, for any person skilled in the art, the present disclosure may be applied to other similar scenarios based on these drawings without creative labor. Unless stated otherwise or obvious from the context, the same reference numeral in the drawings refers to the same structure and operation.

FIG. 1 is a schematic diagram of an exemplary system configuration including a wireless transceiving system according to some embodiments of the present disclosure;

FIG. 2 is a schematic diagram of an exemplary wireless transceiving system according to some embodiments of the present disclosure;

FIG. 3 is a schematic diagram of an exemplary process for wireless transceiving system according to some embodiments of the present disclosure;

FIG. 4 is a schematic diagram of an exemplary processing module according to some embodiments of the present disclosure;

FIG. 5 is a flowchart of an exemplary process for signal processing according to some embodiments of the present disclosure;

FIG. 6 is a schematic diagram of signal time slots according to some embodiments of the present disclosure;

FIG. 7 is a schematic diagram of signal processing according to some embodiments of the present disclosure;

FIG. 8 is a schematic diagram of an exemplary corresponding relationship between power and voltage relating to a power detection unit according to some embodiments of the present disclosure;

FIG. 9 is a flowchart of an exemplary process for signal conditioning according to some embodiments of the present disclosure;

FIG. 10 is a schematic diagram of signal conditioning according to some embodiments of the present disclosure;

FIG. 11 is a flowchart of an exemplary process for signal conditioning according to accord to some embodiments of the present disclosure;

FIG. 12 is a schematic diagram of signal conditioning according to some embodiments of the present disclosure; and

FIG. 13 is a schematic diagram of an exemplary processing module according to some embodiments of the present disclosure.

### DETAILED DESCRIPTION

As used herein the specification and the appended claims, the singular forms “a,” “an,” and “the” may be intended to include the plural forms as well, unless the content clearly dictates otherwise. The terms “comprises” and “comprising” are merely meant to include the steps and elements that are specifically identified, and such steps and elements do not constitute an exclusive list, and the method or device may also include other steps or elements.

Some modules of the system may be referred to in various ways according to some embodiments of the present disclosure, however, any number of different modules may be used and operated in a client terminal and/or a server. The modules are illustrative only, and different of which may be utilized by different aspects of the system and method.

The flowcharts used in the present disclosure illustrate operations that systems implement according to some embodiments of the present disclosure. It is to be expressly understood, the operations above or below may be implemented not in order. Conversely, the operations may be implemented in inverted order, or simultaneously. Besides, one or more other operations may be added to the flowcharts, or one or more operations may be removed from the flowcharts.

The method described in the present disclosure may include receiving an external signal, distinguishing a transmission time slot and a stop time slot from the external signal, and performing wireless signal transceiving in the stop time slot. In some embodiments, the method described in present disclosure may also include deleting a portion of the received external signal that is in the transmission time slot. In some embodiments, the present disclosure may relate to a wireless transceiving system. The wireless transceiving system may include a receiving module, a wireless transceiving module, a processing module, a control module, and a storage module.

The systems and methods described in the present disclosure relates to the systems and methods described in International Patent Application No. PCT/CN2015/075923, entitled “ENVIRONMENTAL CONTROL SYSTEM”, filed on Apr. 3, 2015, International Patent Application No. PCT/CN2015/080160, entitled “ENVIRONMENTAL CONTROL SYSTEM”, filed on May 29, 2015, International Patent Application No. PCT/CN2016/090975, entitled “SAFETY SYSTEMS AND METHODS”, filed on Jul. 22, 2016, and International Patent Application No. ______ (Attorney Docket No. P1B165270PCT), entitled “SYSTEMS AND METHODS FOR CONTROLLING APPLIANCES”, International Patent Application No. ______ (Attorney Docket No.P1B165271PCT) entitled “CONTROL SYSTEM”, International Patent Application No. ______ (Attorney Docket No.P1B165272PCT) entitled “SYSTEMS AND METHODS FOR CONTROLLING ELECTRIC POWER”, filed on the same day as the current application, the entire contents of which are hereby incorporated by reference.

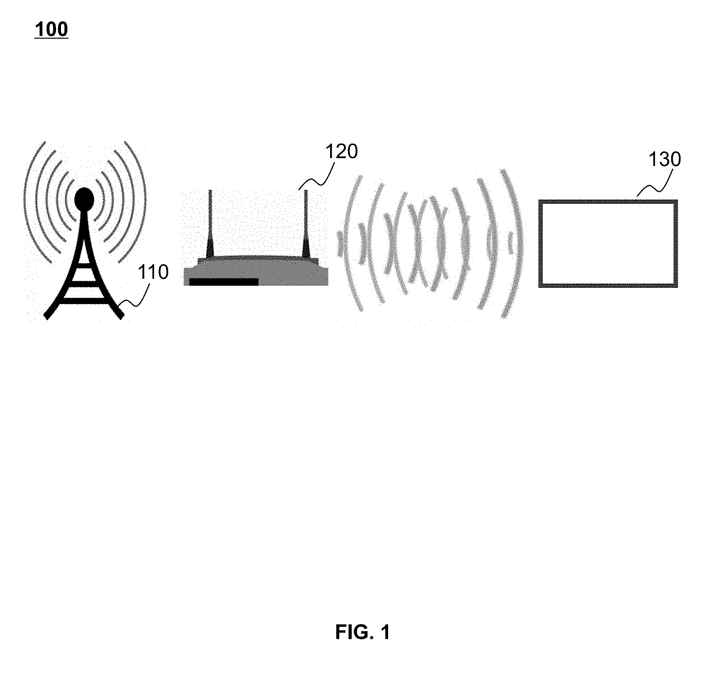

FIG. 1 is a schematic diagram of an exemplary system configuration including a wireless transceiving system according to some embodiments of the present disclosure. The system configuration 100 may include, but is not limited to, one or more signal sources 110, one or more wireless transceiving systems 120, one or more objects 130.

The signal source 110 may emit one or more wireless signals. The wireless signal(s) may interfere with the wireless transceiving system 120. In some embodiments, the signal source 110 may include, but is not limited to, a wireless communication module, a signal tower, a Radar module, a remote control module, a wireless power supply device, a broadcast device, a wireless telephone device, a remote control device, or the like, or any combinations thereof.

The wireless transceiving system 120 may transmit and receive one or more wireless signals. In some embodiments, the wireless transceiving system 120 may be a Radar system. In some embodiments, the wireless transceiving system 120 may transmit a wireless signal that is received by the wireless transceiving system 120 after being reflected by one or more objects. The physical quantity, such as a distance, an azimuth, a velocity, a quantity, and a volume of the object(s), may be measured according to the comparison between the transmitted wireless signal and the reflected wireless signal. In some embodiments, the wireless transceiving system 120 may be a wireless communication system. In some embodiments, the wireless transceiving system 120 may communicate wirelessly with one or more remote devices.

In some embodiments, the object 130 may reflect or absorb the wireless signal. In some embodiments, the object 130 may be a fixed object (e.g., a wall, etc.) or a moving object (e.g., a car, etc.). In some embodiments, the object 130 may reflect a wireless signal transmitted by the wireless transceiving system 120. After receiving the wireless signal transmitted by the object 130, the wireless transceiving system 120 may measure the physical quantity, such as the distance, the relative azimuth, the moving speed of the object 130 relative to the wireless transceiving system 120, or the volume of the object, or the like.

In some embodiments, the object 130 may be a remote device. The object 130 may receive a wireless signal transmitted by the wireless transceiving system 120, and may perform one or more operations according to the received wireless signal. In some embodiments, the object 130 may transmit a wireless signal, which may be received by the wireless transceiving system 120.

In some embodiments, the signal source 110 and the wireless transceiving system 120 may be two subsystems of a system. In some embodiments, the wireless signal may include, but is not limited to, a radio wave, a microwave, an infrared ray, or the like.

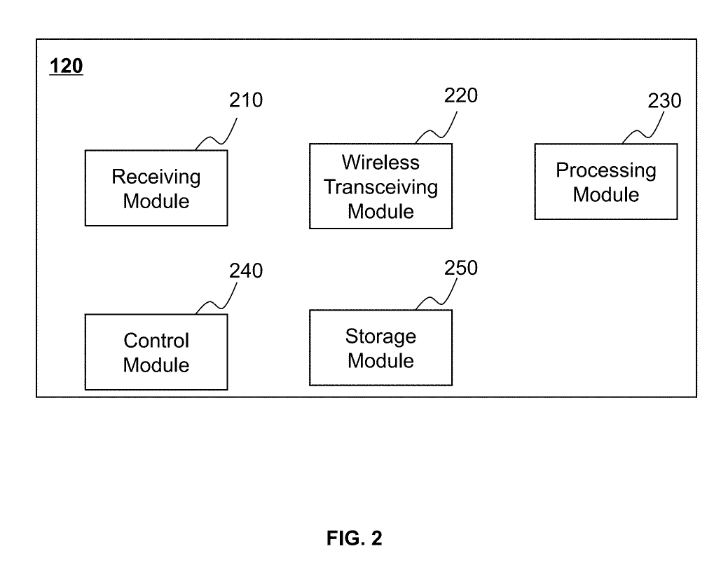

FIG. 2 is a schematic diagram of an exemplary wireless transceiving system according to some embodiments of the present disclosure. The wireless transceiving system 120 may include, but is not limited to, one or more receiving modules 210, one or more wireless transceiving modules 220, one or more processing modules 230, one or more control modules 240, and one or more storage modules 250.

The receiving module 210 may be configured to receive one or more signals. In some embodiments, the receiving module 210 may receive one or more signals from the signal source 110. The reception of the signal(s) may be wired or wireless. In some embodiments, the received one or more signals may be interference signal(s). The interference signal may be a signal from the signal source 110. The frequency of the interference signal may be similar to or the same as the frequency of a wireless signal transmitted or received by the wireless transceiving system 120. The interference signal may interfere with the wireless signal transmitted or received by the wireless transceiving system 120. Further, the interference signal may cause a mistake or an error in the amplitude, frequency or power of the wireless signal received or transmitted by the wireless transceiving system 120.

The wireless transceiving module 220 may receive and transmit wireless signal(s). In some embodiments, the received and transmitted wireless signal(s) may be referred to as useful signal(s). The useful signal may be a signal with a specific frequency used by the wireless transceiving system 120 when the wireless transceiving system 120 performs the wireless signal transceiving. In some embodiments, the specific frequency may include 0.9 GHz, 1.5 GHz, 1.8 GHz, 2.4 GHz, 3.5 GHz, 4.0 GHz, 5.0 GHz, 5.8 GHz, 6.0 GHz, 7.0 GHz, 8.0 GHz, 10.0 GHz, 11.0 GHz, 13.0. GHz, 14 GHz, 15 GHz, 18 GHz, 23 GHz, 24.0 GHz, 35 GHz, 77 GHz, or the like. In some embodiments, the useful signal and the interference signal may have similar or identical frequency. In some embodiments, the wireless transceiving module 220 may be a microwave module. The microwave module may perform the wireless signal transceiving through microwaves (e.g., electromagnetic waves with a frequency of 300 MHz to 300 GHz). The microwave module may be used in the field of Radar ranging. For example, the microwave module may transmit a microwave, and the microwave may be received by the microwave module after being reflected by one or more objects. The physical quantity, such as the distance, the azimuth, the velocity, the quantity and the volume of the object(s), may be measured according to the comparison between the transmitted microwave and the reflected microwave.

The processing module 230 may process a wireless signal. In some embodiments, the processing module 230 may process the interference signal received by the receiving module 210. In some embodiments, the processing module 230 may convert the interference signal into a time slot synchronization signal. The time slot synchronization signal may include one or more transmission time slots and one or more stop time slots. In some embodiments, the interference signal may be a non-zero signal (e.g., a non-zero continuous signal) in the transmission time slot, and may be a zero signal in the stop time slot. For example, the time slot synchronization signal may have a fixed voltage value in the transmission time slot and may have a zero voltage value in the stop time slot. In some embodiments, the time slot synchronization signal may be synchronized with the time slot of the interference signal.

The control module 240 may control one or more other modules in the wireless transceiving system. In some embodiments, the control module 240 may generate a control command. The control command may control the transmission and reception of the wireless transceiving module 220. In some embodiments, the processing module 230 may transmit the transmission time slot and the stop time slot identified in the time slot synchronization signal to the control module 240. Further, the control module 240 may generate one or more control commands according to the transmission time slot and the stop time slot.

The storage module 250 may store signals obtained from the signal source 110 and various data generated during the operations of the wireless transceiving system 120. The storage module 250 may include any device that has a storage function such as a hard disk, a read only memory (ROM), a random access memory (RAM), or the like. The storage module 250 may be local, remote, or a combination thereof. The connection and communication between the storage module 250 and one or more other modules in the wireless transceiving system 120 may be wired, wireless, or a combination thereof.

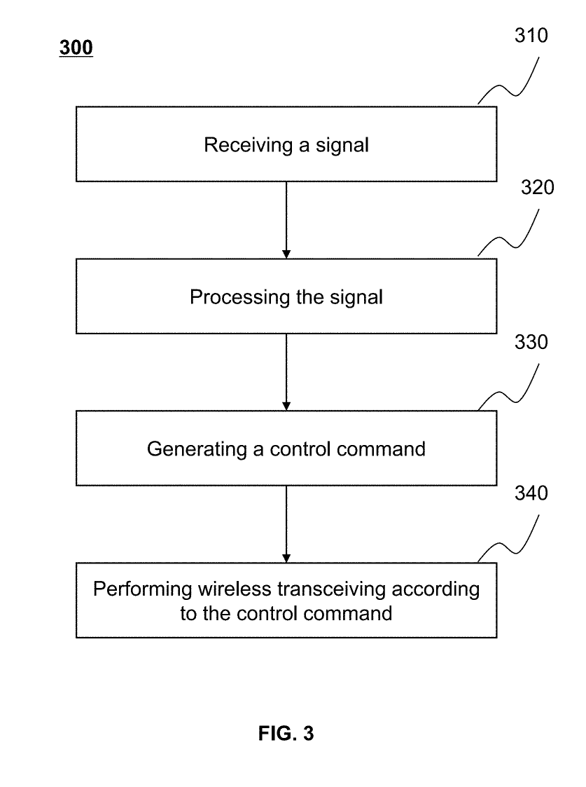

FIG. 3 is a flowchart of an exemplary process for wireless transceiving according to some embodiments the present disclosure. In some embodiments, the wireless transceiving process 300 may be implemented on the wireless transceiving system 120.

In 310, one or more wireless signals may be received. In some embodiments, the one or more wireless signals may be from the signal source 110. In some embodiments, the received one or more signals may be interference signals, which may interfere with the transceiving of the wireless transceiving system 120.

In 320, the received one or more interference signals may be processed. The processing may include converting the one or more interference signals into a slot synchronization signal. The time slot synchronization signal may include one or more transmission time slots and one or more stop time slots.

In 330, a control command may be generated based on the time slot synchronization signal. In some embodiments, the control command may control the wireless transceiving. In some embodiments, the time slot synchronization signal may include one or more transmission time slots and one or more stop time slots. The control command may include performing the wireless transceiving in the one or more stop time slots to reduce the interference of the one or more wireless signals. In some embodiments, the control command may also include stopping the transceiving in the one or more transmission time slots. In some embodiments, the control command may also include processing the one or more interference signals received in the one or more transmission time slots.

In 340, the wireless transceiving may be performed according to the control command. In some embodiments, the wireless transceiving may include performing the transceiving in a first time slot and stopping the transceiving in a second time slot. For example, the wireless transceiving may include performing the wireless transceiving in the stop time slot of the one or more wireless signals, and stopping the transceiving in the transmission time slot of the one or more wireless signals. In some embodiments, the wireless transceiving may include processing a signal received in the transmission time slot of the one or more interference signals. The processing may include filtering, deleting, truncating, compressing, or the like, or any combination thereof. In some embodiments, the processing may be performed based on the control instruction generated in operation 330. For example, the frequency of the interference signal(s) may be different from the frequency of a signal normally transmitted and received by the system 120 (e.g., a useful signal). In 340, the received signal in the transmission time slot of the interference signal may be filtered to remove the interference signal. As another example, the frequency of the interference signal may be the same as or similar to the frequency of the signal normally transmitted and received by the system 120 (e.g., a useful signal). In 340, the received signal in the transmission time slot of the interference signal may be deleted to remove the interference signal. In some embodiments, the useful signal deleted in the transmission time slot may be obtained by being re-received in other time slots.

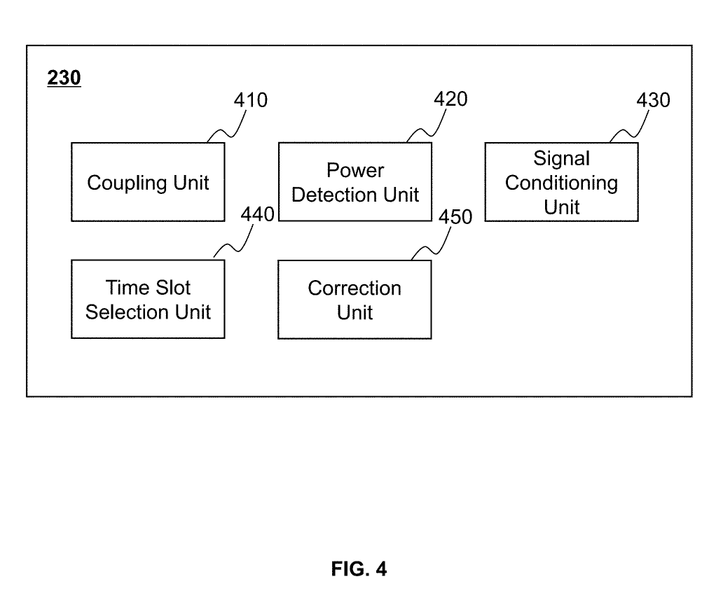

FIG. 4 is a schematic diagram of an exemplary processing module according to some embodiments of the present disclosure. The processing module 230 may include one or more coupling units 410, one or more power detection units 420, one or more signal conditioning units 430, one or more time slot selection units 440, and one or more correction units 450.

The coupling unit 410 may perform a coupling processing on a signal. The coupling processing may include dividing an input signal into a plurality of sub-signals. A waveform of the sub-signal(s) may be the same as a waveform of the input signal. In some embodiments, the sub-signal(s) may include an output signal and a coupled signal. In some embodiments, a waveform of the output signal and/or the coupled signal may be the same as or similar to the waveform of the input signal. In some embodiments, an amplitude of the coupled signal and/or the output signal may be different from an amplitude of the input signal. For example, the amplitude of the coupled signal may be less than the amplitude of the input signal and/or the output signal. In some embodiments, the amplitude of the coupled signal may be changed by the coupling unit 410. In some embodiments, the output signal may be transmitted to a target location of the input signal through a wireless transmission device. For example, the input signal may be a radio wave in the air. The coupling unit 410 may generate two signals whose waveforms are the same as the waveform of the radio wave. A signal having a smaller amplitude (in the condition of having the same waveform, the amplitude also being referred to as a power) may be used as the coupled signal for subsequent process, while a signal having a larger amplitude may be used as the output signal which may be re-transmitted to maintain the power of the input signal and the original target location.

The power detection unit 420 may be configured to detect a power of a signal, and generate a corresponding value based on the power of the signal. In some embodiments, the power detection unit 420 may generate an envelope signal corresponding to the signal according to the power of the signal. The voltage of the envelope signal may correspond to the power of the signal.

The signal conditioning unit 430 may be configured to condition a signal. The conditioning may include processing a signal to generate a time slot synchronization signal. The time slot synchronization signal may include one or more transmission time slots and one or more stop time slots. In some embodiments, the time slot synchronization signal may have a fixed voltage value in the transmission time slot and may be zero in the stop time slot. In some embodiments, the time slot synchronization signal may be a square wave signal.

The time slot selection unit 440 may be configured to select one or more time slots in a signal. In some embodiments, the time slot may include a transmission time slot and/or a stop time slot. In some embodiments, the time slot selection unit 440 may transmit the selected time slot to the control module 240. The control module 240 may generate a control instruction based on the selected time slot according to the process described in some embodiments of the present disclosure.

The correction unit 450 may be configured to perform a synchronous matching for the time slots in a plurality of signals and correct the matched time slots. In some embodiments, the correction unit 450 may perform the synchronous matching for the transmission time slot and the stop time slot in two signals. In some embodiments, the correction unit 450 may further include correcting one signal of the two signals according to the synchronization matching of the transmission time slot and the stop time slot. In some embodiments, the correction may synchronize the transmission time slot and the stop time slot of the two signals.

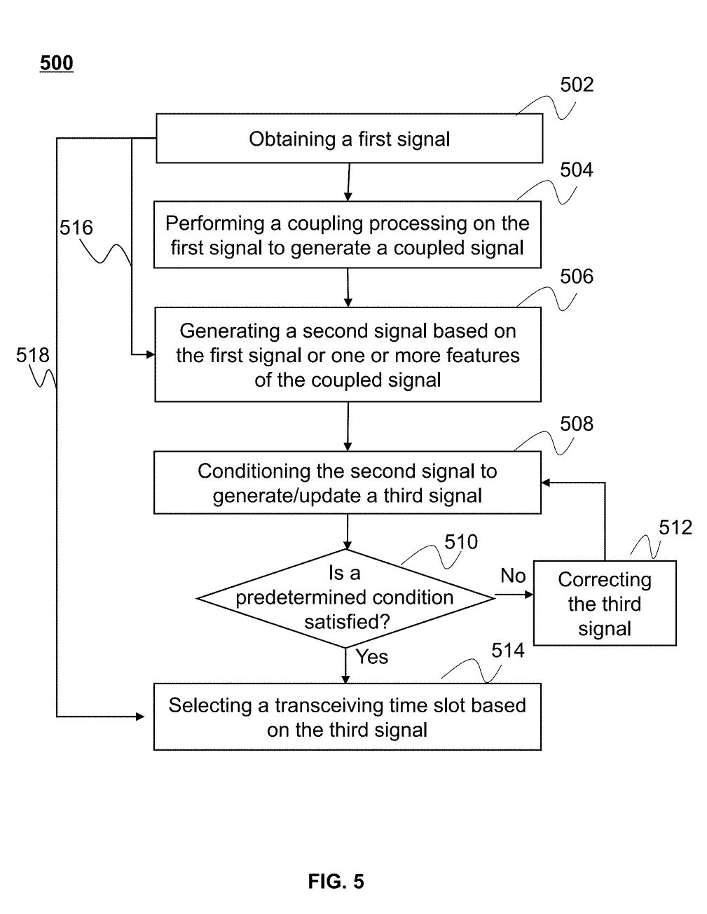

FIG. 5 is a flowchart of an exemplary process for signal processing according to some embodiments of the present disclosure. In some embodiments, the process 500 (also referred to as signal processing process 500) may be implemented by the processing module 230.

In 502, a first signal may be obtained. In some embodiments, the first signal may be a signal received by the receiving module 210. In some embodiments, the first signal may be obtained from the signal source 110. For example, the first signal may be an interference signal.

In 504, a coupling processing may be performed on the obtained first signal. In some embodiments, the coupling processing may include generating an output signal and a coupled signal based on the first signal. In some embodiments, the waveforms of the output signal and the input signal may be the same or similar. In some embodiments, the waveforms of the coupled signal and the input signal may be the same or similar. In some embodiments, an amplitude of the coupled signal and/or the output signal may be different from an amplitude of the input signal. For example, the amplitude of the coupled signal may be smaller than the amplitude of the input signal and/or the output signal. In some embodiments, the amplitude of the coupled signal may be adjusted.

In 506, a second signal may be generated based on one or more features of the coupled signal. In some embodiments, the feature(s) of the coupled signal may include, but are not limited to, an amplitude (e.g., a voltage), a current, a power, a frequency, or the like, or any combination thereof. In some embodiments, the second signal may be generated based on the power of the coupled signal. The voltage value of the second signal may correspond to the power value of the coupled signal. In some embodiments, the second signal may be an envelope signal. The envelope signal may be a continuous curve representing the maximum power value of the coupled signal.

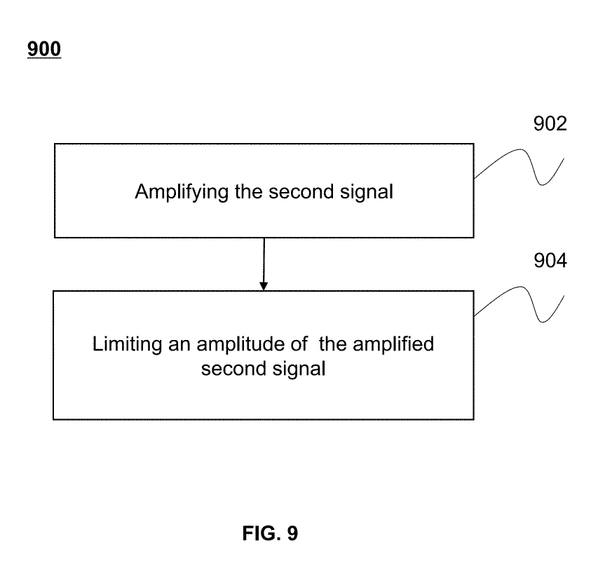

In 508, the second signal may be conditioned to generate a third signal. The conditioning may be found elsewhere in the present disclosure (e.g., FIG. 9 and the description thereof). In some embodiments, the third signal may be a time slot synchronization signal. For example, the time slot synchronization signal may include one or more transmission time slots and one or more stop slots. In some embodiments, the time slot synchronization signal may have a non-zero voltage value (e.g., a fixed non-zero voltage value) in the one or more transmission time slots and may be zero in the one or more stop time slots.

In 510, whether a predetermined condition is satisfied may be determined. In some embodiments, the determination may include determining whether a transmission time slot and a receiving time slot of the third signal are synchronized with the first signal. In 512, the third signal may be corrected if the transmission time slot and the receiving time slot of the third signal are not synchronized with the first signal. The correction may include adjusting a width of one or more time slots. For example, the correction may include performing a translation on the time slot for the third signal.

Returning to operation 508, the third signal may be updated after being corrected. The updating may include replacing the third signal previously determined with the corrected third signal. If the transmission time slot and the receiving time slot of the third signal are synchronized with the first signal, operation 514 may be further performed.

In 514, a transceiving time slot may be selected based on the generated third signal. According to some embodiments disclosed in the present disclosure, the third signal may be a time slot synchronization signal. In some embodiments, one or more transmission time slots and one or more stop time slots in the third signal may be determined. Further, a transceiving time slot may be determined based on the one or more transmission time slots and one or more stop time slots. In some embodiments, the transceiving time slot may be synchronized with the one or more stop time slots.

In some embodiments, as indicated by arrow 516, in operation 506, a second signal may be directly generated based on the first signal obtained in operation 502 without performing the coupling processing.

In some embodiments, the first signal may carry a corresponding third signal, e.g., a time slot synchronization signal. As indicated by arrow 518, after obtaining the first signal and the third signal in operation 502, the transceiving time slot may be selected directly in operation 514 based on the third signal. The selection of the transceiving time slot may refer to the description of operation 514.

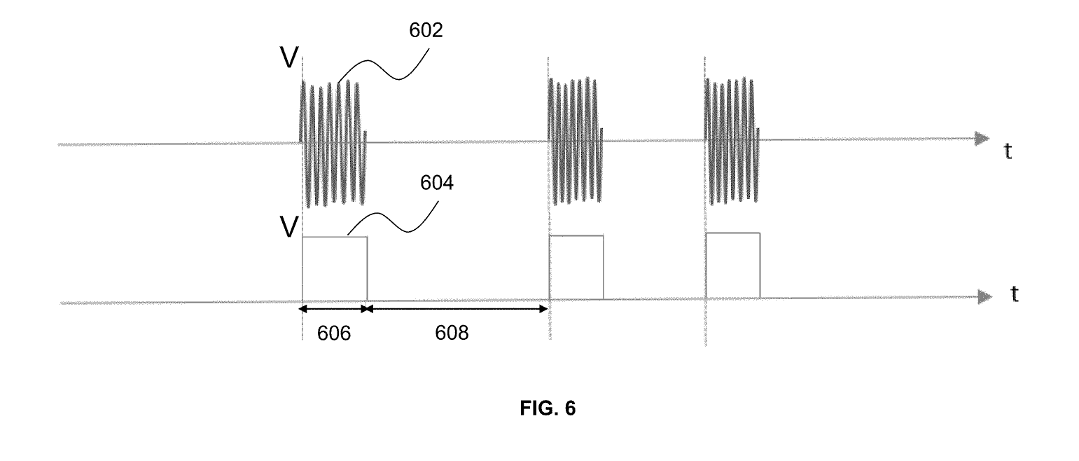

FIG. 6 is a schematic diagram of signal time slots according to some embodiments of the present disclosure. As shown in FIG. 6, a signal 602 may be the first signal (or the interference signal) described in some embodiments of the present disclosure. A signal 604 may be the third signal (or the time slot synchronization signal) described in some embodiments of the present disclosure. In some embodiments, the signal 604 may be determined based on the signal 602 through one or more operations of the process 500. In some embodiments, the signal 604 may include one or more time slots. Furthermore, the time slot(s) may include one or more transmission time slots 606 and one or more stop time slots 608. As shown in FIG. 6, the signal 604 has a fixed voltage value in the transmission time slot 606 and a zero voltage value in the stop time slot 608. In some embodiments, the transmission time slot and the stop time slot of the signal 604 may be synchronized with the signal 602. For example, the non-zero portion of the signal 602 corresponds to the transmission time slot of the signal 604, and the portion of the signal 602 that is zero corresponds to the stop time slot of the signal 604.

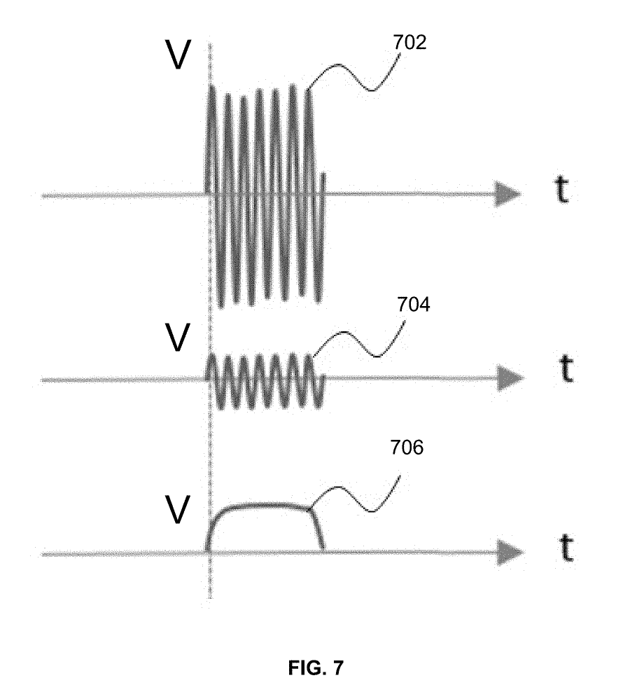

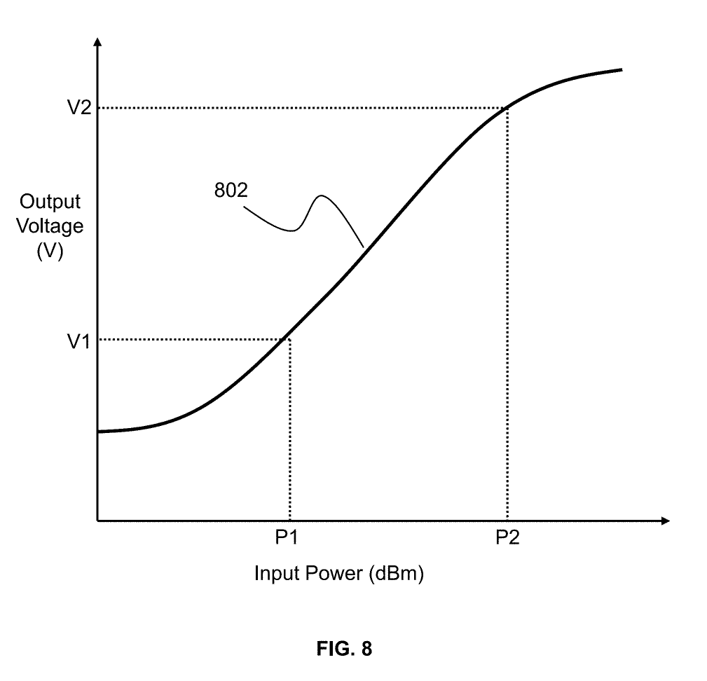

FIG. 7 is a schematic diagram of signal processing according to some embodiments of the present disclosure. As shown in FIG. 7, a signal 702 may be the first signal (or the interference signal) described in some embodiments of the present disclosure. A signal 704 may be the coupled signal described in some embodiments of the present disclosure. A signal 706 may be the second signal (or the envelope signal) as described in some embodiments of the present disclosure. In some embodiments, the signal 704 may be generated by performing a coupling processing on the signal 702 (e.g., operation 504). In some embodiments, the waveforms of the signal 702 and the signal 704 are the same. In some embodiments, the signal 706 may be generated by performing power detection on the signal 704 (e.g., operation 506). The power detection may be implemented by the power detection unit 420. In some embodiments, the voltage of the signal 706 may have a corresponding relationship with the power of the signal 704. The corresponding relationship may be related to the power detection unit 420. For example, for the signal 704 with same power, the voltage of the signal 706 generated by different power detection units 420 may be different. For example, a power detection curve may be used to represent the corresponding relationship between the voltage of the signal 706 and the power of the signal 704. For example, different power detection units 420 may have different power detection curves. An exemplary power detection curve may be found in, e.g., FIG. 8 and the descriptions thereof. In some embodiments, the signal 706 may be an envelope signal, i.e., the signal 706 is a continuous curve representing the maximum power value of the signal 704. In some embodiments, the signal 706 may be conditioned according to the process described in some embodiments of the present disclosure to generate a time slot synchronization signal (e.g., the signal 606).

FIG. 8 is a schematic diagram of an exemplary corresponding relationship between power and voltage relating to a power detection unit according to some embodiments of the present disclosure. As described in some embodiments of the present disclosure, the power detection unit may generate an output signal having a corresponding voltage according to the power of the input signal. As shown in FIG. 8, the power detection curve 802 may be a correlation curve of the input power and the output voltage. For example, if the power of the input signal is P1, the voltage of the output signal may be V1. Similarly, if the power of the input signal is P2, the voltage of the output signal may be V2. In some embodiments, the power detection unit 420 may have a working range. In other words, the power detection unit 420 may only accept an input signal with a certain power. In some embodiments, the input signal may be a first signal or a coupled signal. The size of the coupled signal may be adjusted by the coupling unit 410. In some embodiments, the size of the coupled signal may be adjusted to the working range of the power detection unit 420.

FIG. 9 is a flowchart of an exemplary process for signal conditioning according to some embodiments of the present disclosure. In some embodiments, the signal conditioning process 900 may be implemented by the signal conditioning unit 430. In some embodiments, the process 900 (i.e., the signal conditioning process 900) may condition a second signal (or an envelope signal) described in some embodiments of the present disclosure to generate a third signal (or a time slot synchronization signal).

In 902, the second signal may be amplified. In some embodiments, the amplifying operation may include amplifying an amplitude of the second signal while maintaining a waveform of the second signal. In some embodiments, the amplifying operation may be implemented by one or more signal amplifier in the signal conditioning unit 430.

In 904, the amplitude of the amplified second signal may be limited. The limiting operation may include setting a threshold, and deleting a portion of the amplified second signal that is greater than the threshold.

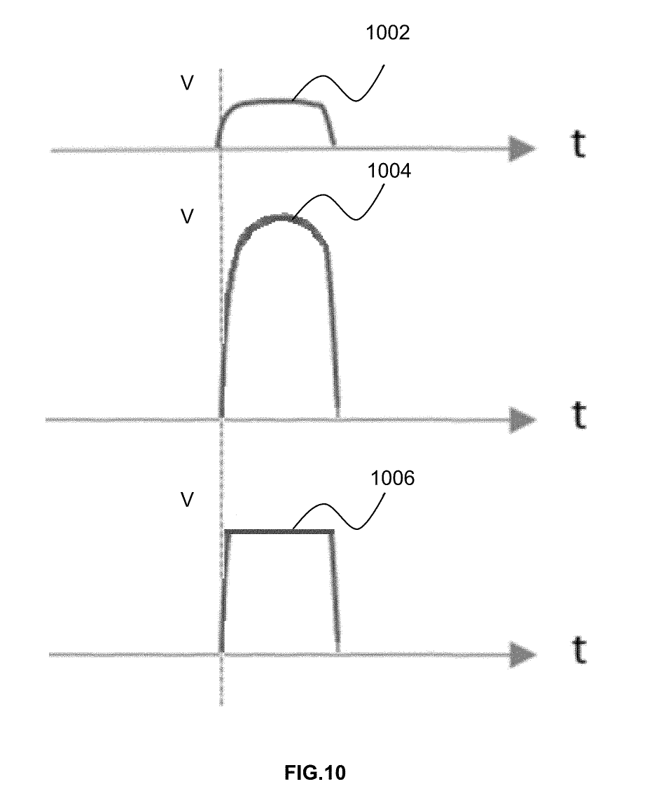

FIG. 10 is a schematic diagram of signal conditioning according to some embodiments of the present disclosure. A signal 1002 may be the second signal (or the envelope signal) described in some embodiments of the present disclosure. In some embodiments, the signal 1002 may be amplified by the amplifying operation described in operation 902 to generate a signal 1004. As shown in FIG. 10, the waveform of the signal 1002 and the signal 1004 may be identical. The amplitude of the signal 1004 may be larger than the amplitude of the signal 1002. In some embodiments, a signal 1006 may be generated by limiting the amplitude of the signal 1004 (e.g., operation 904). In some embodiments, the signal 1006 may be the same as or similar to the time slot synchronization signal or the third signal in some embodiments of the present disclosure. In some embodiments, the higher the magnification is, the closer to the time slot synchronization signal the signal 1006 is. In some embodiments, a portion of the signal 1006 may have a fixed voltage value, and the other portion of the signal 1006 may be zero. The portion of the signal 1006 that has the fixed voltage value may be the transmission time slot of the signal 1006, and the portion of the signal 1006 that has the zero-value may be the stop time slot of the signal 1006.

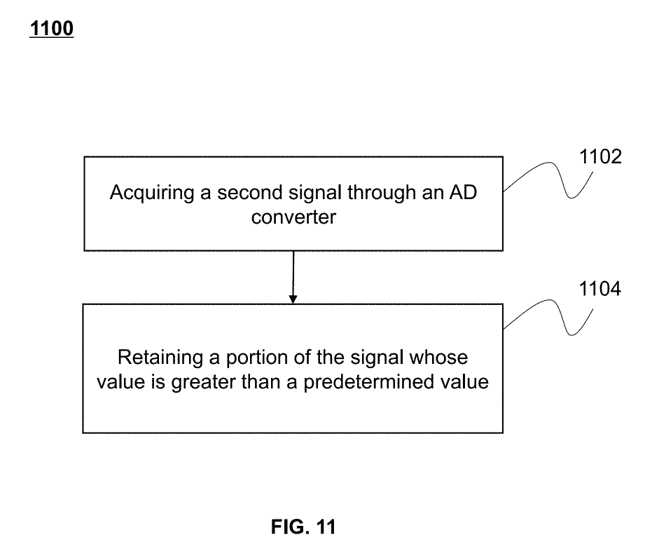

FIG. 11 is a flowchart of an exemplary process for signal conditioning according to some embodiments of the present disclosure. In some embodiments, the process 1100 (i.e., the signal conditioning process 1100) may be implemented by the signal conditioning unit 430. In some embodiments, the process 1100 may condition a second signal (or an envelope signal) described in some embodiments of the present disclosure to generate a third signal (or a time slot synchronization signal).

In 1102, a second signal may be acquired by an analog to digital converter (ADC). The acquisition operation may include receiving an analog signal and converting the received analog signal into a digital signal. In some embodiments, the value of the digital signal may be proportional to the size of the analog signal.

In 1104, a portion of the signal whose value is greater than a predetermined value may be retained. In some embodiments, the retaining operation may be implemented via software. In some embodiments, the retaining operation may also be implemented by an electronic device, such as a judgment circuit, or the like.

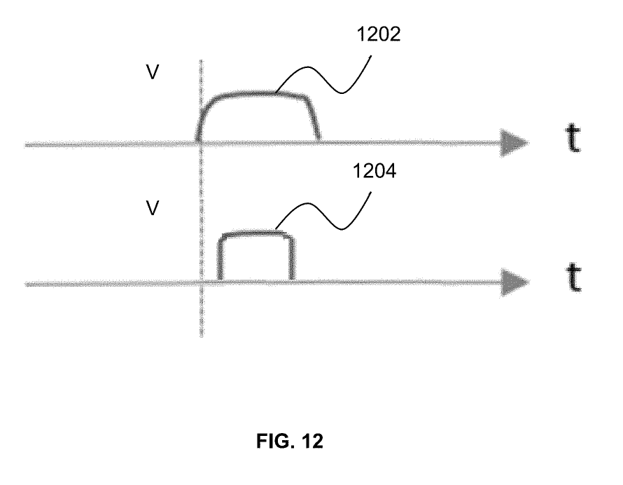

FIG. 12 is a schematic diagram of signal conditioning according to some embodiments of the present disclosure. As shown in FIG. 12, a signal 1202 may be the second signal (e.g., the envelope signal) described in some embodiments of the present disclosure. In some embodiments, the signal 1202 may be converted to a slot synchronization signal 1204 according to the process 1100. In some embodiments, the amplitude of the signal 1202 may be the same as the amplitude of the signal 1204. In some embodiments, the transmission time slot of the signal 1204 may be narrower than the transmission time slot of the signal 1202. In some embodiments, the portion of the transmission time slot, which belongs to the signal 1202 but not to the signal 1204, has a non-zero signal and the power and voltage of which are lower. According to some embodiments of the present disclosure, the portion of the transmission slot, which belongs to the signal 1202 but not to the signal 1204, may not interfere with the transceiving of the wireless transceiving system 120 or the interference may be negligible. In some embodiments, the wireless transceiving system 120 may perform transceiving in the transmission time slot of the signal 1202 and not in the transmission time slot of the signal 1204.

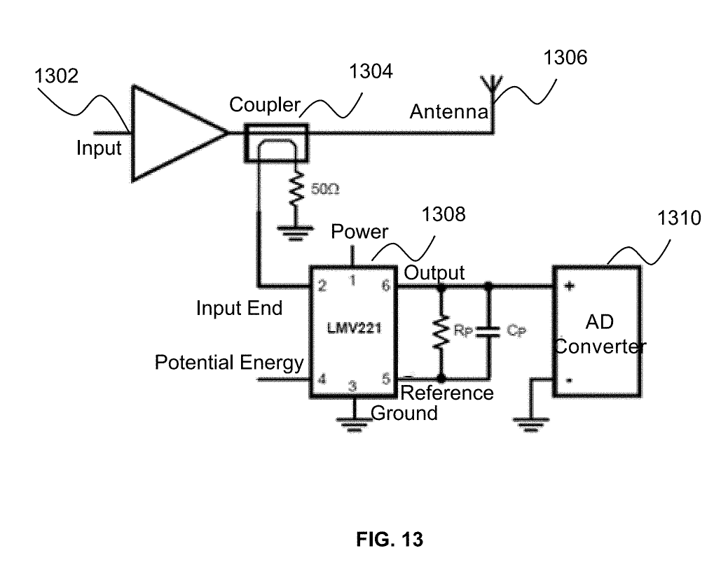

FIG. 13 is a schematic diagram of an exemplary processing module according to some embodiments of the present disclosure. As shown in FIG. 13, the processing module may receive an input signal 1302. In some embodiments, the input signal may be a signal received by the receiving module 210. In some embodiments, the input signal may be from the signal source 110. Furthermore, the input signal may be an interference signal. In some embodiments, a coupler 1304 may perform coupling processing on the input signal. In some embodiments, the coupling processing may include generating an output signal and a coupled signal based on the input signal. In some embodiments, the output signal may be transmitted to an antenna 1306. The antenna 1306 may transmit the output signal. In some embodiments, a power detector 1308 may generate an envelope signal based on the coupled signal. The voltage value of the envelope signal may correspond to the power value of the coupled signal. In some embodiments, the AD converter 1310 may acquire the envelope signal and retain a portion of the envelope signal whose value is greater than a predetermined value to generate a time slot synchronization signal.

Having thus described the basic concepts, it may be rather apparent to those skilled in the art that the disclosure of the invention is by way of example only and is not limiting to the present disclosure. Various alterations, improvements, and modifications of the present disclosure may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this disclosure are not necessarily all referring to the same embodiment. In addition, certain features, structures, or features may be combined as appropriate in one or more embodiments of the present disclosure.

Moreover, it will be appreciated by those skilled in the art, aspects of the present disclosure may be illustrated and described herein in any number of patentable classes or context including any new and useful process, machine, manufacture, or composition of matter, or any new and useful improvements thereof. Accordingly, various aspects of the present disclosure may be implemented entirely hardware, entirely software (including firmware, resident software, microcode, etc.) or combination of hardware and software. The above hardware or software may be referred to herein as “data block”, “module”, “engine”, “unit”, “component” or “system”. In addition, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. The propagating signal may have a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. The program code embodied on a computer readable signal medium may be transmitted using any suitable medium, including a radio, cable, optical fiber cable, radio frequency signal, or the like, or any combination of the forgoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. However, the method of disclosure does not mean that the present disclosure object requires more features than the features mentioned in the claims. Rather, claim subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. For example, “about,” “approximate,” or “substantially” may indicate ±20% variation of the value it describes, unless otherwise stated. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent applications, publications of patent applications, and other materials cited herein, such as articles, books, instructions, publications, documents, etc., are hereby incorporated by reference in their entirety. Application history documents that are inconsistent or conflicting with the contents of the present application are excluded, and documents (currently or later attached to the present application) that limit the widest range of the scope of the present application are also excluded. By way of example, should there be any inconsistency or conflict between the description, definition, and/or the use of a term associated with any of the incorporated material and that associated with the present document, the description, definition, and/or the use of the term in the present document shall prevail.

In closing, it should be understood that the embodiments of the application disclosed herein are merely illustrative of the principles of the embodiments of the present application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system comprising:
a receiving module configured to receive a first signal from a signal source;
a power detection unit configured to generate a second signal according to a power of the first signal;
a signal conditioning unit configured to generate a third signal according to the second signal;
a time slot selection unit configured to determine one or more time slots in the third signal; and
a wireless transceiving module configured to perform wireless signal transceiving in at least one of the one or more time slots.

2. The system of claim 1, wherein the one or more time slots in the third signal include a transmission time slot and a stop time slot.

3. The system of claim 2, wherein the wireless transceiving module performs the wireless signal transceiving in the stop time slot of the third signal.

4. The system of claim 2, the wireless transceiving module deletes a portion of the received first signal that is in the transmission time slot.

5. The system of claim 1, further comprising a coupler configured to adjust the size of the first signal.

6. The system of claim 1, wherein the signal conditioning unit includes a signal amplifier configured to amplify the second signal.

7. The system of claim 1, wherein the signal conditioning unit includes an AD converter configured to acquire the second signal.

8. The system of claim 7, wherein the AD converter further includes a judgment circuit configured to control the acquisition of the second signal.

9. The system of claim 2, further comprising a correction circuit, the correction circuit being configured to correct the third signal according to a synchronization of the transmission time slot and the stop time slot of the third signal with the first signal.

10. A method, comprising:
receiving a first signal from a signal source;
generating a second signal according to a power of the first signal;
generating a third signal according to the second signal;
determining one or more time slots in the third signal;
performing wireless signal transceiving in at least one of the one or more time slots.

11. The method of claim 10, wherein the one or more time slots in the third signals include a transmission time slot and a stop time slot.

12. The method of claim 11, wherein the performing wireless signal transceiving in at least one of the one or more time slots comprises: performing the wireless signal transceiving in the stop time slot of the third signal.

13. The method of claim 11, further comprising:
deleting a portion of the received first signal that is in the transmission time slot.

14. The method of claim 10, further comprising adjusting the size of the first signal.

15. The method of claim 10, further comprising acquiring the second signal by an AD converter.

16. The method of claim 15, further comprising controlling the acquisition of the second signal by a judgment circuit.

17. The method of claim 11, further comprising correcting the third signal according to a synchronization of the transmission time slot and the stop time slot of the third signal with the first signal.

18. A computer-readable storage medium storing executable instructions, wherein the executable instructions are configured to cause a computing device to:
receive a first signal from a signal source;
generate a second signal according to a power of the first signal;
generate a third signal according to the second signal;
determine one or more time slots in the third signal,
perform wireless signal transceiving in at least one of the one or more time slots.

19. The computer-readable storage medium of claim 18, wherein the one or more time slots in the third signal include a transmission time slot and a stop time slot.

20. The computer-readable storage medium of claim 19, wherein the wireless transceiving module performs the wireless signal transceiving in the stop time slot of the third signal.
